(19) United States
(12) Patent Application Publication
(10) Pub. No.: US 2013/0134070 A1
(43) Pub. Date: May 30, 2013

(54) Method for Seperating Carbon Nanotubes with Different Conductive Properties

(71) Applicants: Pengfei Wang, Shanghai (CN); Wei Zhang, Shanghai (CN)

(72) Inventors: Pengfei Wang, Shanghai (CN); Wei Zhang, Shanghai (CN)

(73) Assignee: FUDAN UNIVERSITY, Shanghai (CN)

(21) Appl. No.: 13/498,145

(22) PCT Filed: Nov. 29, 2011
(86) PCT No.: PCT/CN2011/001988

§ 371 Date: Aug. 22, 2012

(51) Int. Cl. B03C 1/02; B82B 3/00

(52) U.S. Cl. 209/3.1; 977/742

(57) ABSTRACT

This invention belongs to the technical field of integrated circuit manufacturing and specifically relates to a method for separating carbon nanotube materials with different conductive properties. The method is comprised of: immersing an integrated circuit material containing metallic carbon nanotubes and semiconductor carbon nanotubes into fluid; introducing the fluid into the same container from the same inlet; on the four sides of the container, forming an electric field and arranging a pair of magnetic poles generating magnetic lines vertical to the electric field; changing the direction and intensity of the electric lines of the electric field and those of the magnetic fields to separate the metallic carbon nanotubes from the semiconductor carbon nanotubes. By means of the method of this invention, the purity of the obtained semiconductor carbon nanotubes and the metallic carbon nanotubes is high, so the product yield of the integrated circuit containing the semiconductor carbon nanotubes is capable of being greatly enhanced. This method is simple, easy, low in cost and capable of greatly reducing the manufacturing cost of high-purity carbon nanotubes.

### TECHNICAL FIELD

This invention belongs to the technical field of integrated circuit manufacturing and specifically relates to a method for separating carbon nanotube materials with different conductive properties.

BACKGROUND TECHNOLOGY

With the development of integrated circuits, continuously narrowing transistors based on silicon materials becomes increasingly difficult. Due to their small size and high conductivity, semiconductor carbon nanotubes have a high value when applied to integrated circuit manufacturing, and field-effect tubes consisting of the semiconductor carbon nanotubes are capable of conducting functions similar to those of the metal-oxide-silicon (MOS) field-effect tubes. FIG. 1 illustrates a carbon nanotube field-effect tube. A layer of insulator is arranged between a grid 101 and a semiconductor carbon nanotube 104 for insulation and, by applying voltage to the gate 101, the current between a source 102 and a drain 103 is capable of being controlled. Besides, metallic carbon nanotube materials are capable of being applied in the interconnection of chips because of their relatively low resistance.

At present, the manufacturing process of semiconductor carbon nanotubes is usually accompanied with the generation of metallic carbon nanotubes. When the semiconductor carbon nanotube 104 as shown in FIG. 1 is replaced by metallic carbon nanotubes, the current between the source and the drain of this field-effect tube is made to be beyond the control of the voltage of the gate, which means the field-effect tube consisting of the metallic carbon nanotubes is out of operation. Therefore, the separation between the semiconductor carbon nanotubes and the metallic carbon nanotubes is of great significance to field-effect manufacturing.

Refer to the China Patent Application No. 200580026051.0. At present, the method for separating the semiconductor carbon nanotubes from the metallic carbon nanotubes usually adopts centrifugal separation by the steps of absorbing the carbon nanotubes with a surfactant to make the weights of carbon nanotubes with different properties change and then carrying out centrifugal purification. Such a method requires the use of special surfactants and is subject to long-time centrifugal purification process and high cost, therefore making mass production difficult.

In this invention, the contents of this patent are incorporated as the prior art by reference.

### DESCRIPTION OF THIS DISCLOSURE

This invention aims to provide a simple, feasible and low-cost method for separating carbon nanotube materials with different conductive properties.

The method for separating the carbon nanotube materials with different conductive properties is specifically comprised of the following steps:

a) soaking an integrated circuit material in fluid, wherein the integrated circuit material at least comprises a mixture of metallic carbon nanotubes and semiconductor carbon nanotubes; the fluid is non-conductive or high-resistance;

b) pouring the fluid into a container;

c) setting an electric field and a pair of magnetic poles which form magnetic lines and are vertical to the electric field around the container, wherein both the magnetic lines of the pair of magnetic poles and the electric lines of the electric field penetrate the container;

d) changing the directions and lengths of the electric lines of the electric field and those of the magnetic lines, wherein the integrated circuit material under the act of the varying electric field and magnetic field forces the metallic carbon nanotubes and the semiconductor carbon nanotubes to be separated;

e) respectively collecting the separated integrated circuit materials (including the separated metallic carbon nanotubes and semiconductor carbon nanotubes).

In this invention, the magnetic field generated by the pair of magnetic poles is a permanent magnetic field or an electromagnetic field with an intensity of 0.00001-10 T.

In this invention, the carbon nanotubes are primarily semiconductor carbon nanotubes, metallic carbon nanotubes, monoatomic-layered carbon nanotubes, etc.

The preparation method of this invention has the beneficial effect that the metallic carbon nanotubes and the semiconductor carbon nanotubes are separated by a simple and reliable method. According to this method, the separation technology is of high selectivity, and the purity of the separated materials is superior to that obtained by the prior art, because the metallic carbon nanotubes and the semiconductor carbon nanotubes are characterized in different conductivities in particular magnetic fields.

### BRIEF DESCRIPTION OF THE ATTACHED DRAWINGS

FIG. 1 is a structural view of a semiconductor carbon nanotube-based field-effect tube.

FIG. 2 is a schematic view of the integrated circuit material separating method of this invention.

FIG. 3 is a micro-environment schematic view of the carbon nanotubes in the process of separating the integrated circuit material of this invention.

FIG. 4 is a schematic view of an embodiment of the moving carbon nanotubes after the electric field carries out alternation in the magnetic field generated by a pair of magnetic poles in FIG. 2.

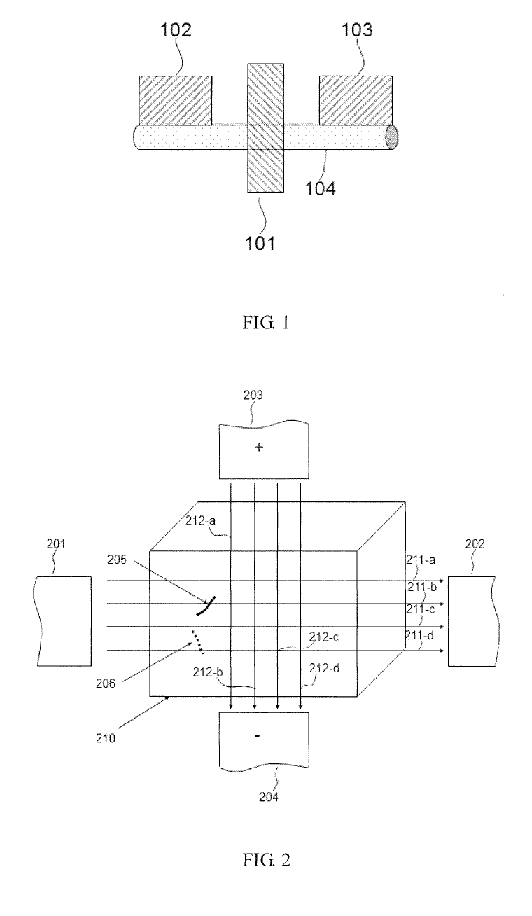

### OPTIMAL EMBODIMENT OF THIS INVENTION

This invention is further described in detail by combining the attached drawings and the embodiment.

In this invention, the term “fluid” refers to a nonconductive or high-resistance fluid.

FIG. 2 is a schematic view of the carbon nanotube separating method of this invention, namely the schematic view of the method for separating the metallic carbon nanotubes and the semiconductor nanotubes, wherein the carbon nanotube 205 is one of a plurality of metallic carbon nanotubes and the carbon nanotube 206 is one of a plurality of semiconductor nanotubes. The abovementioned carbon nanotubes are immersed in the fluid in a container 210. A magnetic pole 201 is an N pole or an S pole, while a magnetic pole 202 is opposite in polarity to magnetic pole 201. In this way, the magnetic pole 201 and the magnetic pole 202, which are opposite, form a magnetic field. Magnetic lines 211-a, 211-b, 211-c and 211-d represent the magnetic lines between the magnetic pole 201 and the magnetic pole 202. Electric lines 212-a, 212-b, 212-c and 212-d, vertical to the magnetic lines 211-a, 211-b, 211-c and 211-d, are generated by a pair of electrodes 203 and 204, which are of opposite polarity. The abovementioned magnetic pole pair and electrode pair are both arranged on the periphery of the container 210.

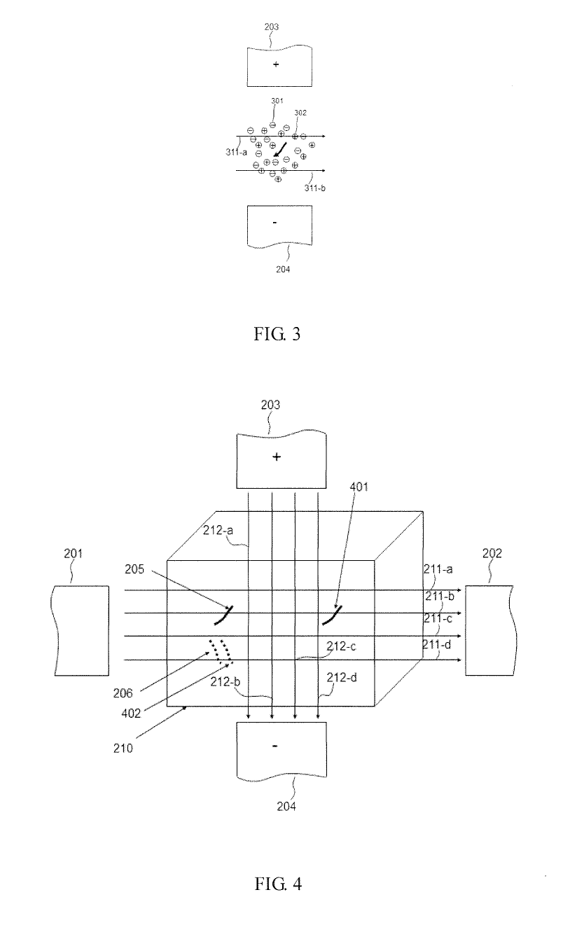

When the electric field between the electrode 203 and the electrode 204 are alternated, which means that the original positive electrode changes into the negative one, gradually, and the original negative electrode changes into the positive one, gradually, the two ends of the metallic carbon nanotube 205 will correspondingly induct charges, and the current will pass through the inside of the nanotube. FIG. 3 is a micro-environment in which the carbon nanotube 205 exists as shown in FIG. 2. Magnetic lines 311-a and 311-b represent the direction of the magnetic field. The electrode 203 carries a positive charge, and the electrode 204 carries a negative charge. The two ends of the carbon nanotube are capable of inducting the charges. When the electrode 203 changes to carry a negative charge and the electrode 204 changes to carry a positive charge, the current will pass through the carbon nanotube. Because the resistance of the metallic carbon nanotubes is far smaller than that of the semiconductor carbon nanotube, the current passing through the metallic carbon nanotube is larger than that passing through the semiconductor carbon nanotube. As show in FIG. 2, when the current passing through the carbon nanotubes 205 and 206 and the magnetic line between the magnetic poles 201 and 202 are at a certain included angle, a Lorentz force will be generated which drives the carbon nanotubes to move. The current passing through the metallic carbon nanotube 205 is larger than that passing through the semiconductor carbon nanotube 206, so the moving speed of the carbon nanotube 205 is faster than that of the carbon nanotube 206. This means that, over the same time period, the moving distance of the carbon nanotube 205 is longer than that of the carbon nanotube 206. Due to different moving distances, the metallic carbon nanotubes and the semiconductor nanotubes are capable of being separated.

FIG. 4 is a schematic view of the movement of the carbon nanotubes in the alternating electric field in FIG. 2. The figure shows the position of the carbon nanotube after the electric and magnetic fields are alternated synchronously. For example, after the magnetic and electric fields are alternated synchronously, the metallic carbon nanotubes move from the position where the carbon nanotube 205 exists to the position wherein the metallic carbon nanotube 401 exists. Due to the fact that the semiconductor carbon nanotubes move very slowly, the semiconductor carbon nanotubes move from the position of the carbon nanotube 206 to the position of the semiconductor carbon nanotube 402 after the electric poles 201 and 202 are moved. After multiple alternations of the electric and magnetic fields, the metallic carbon nanotubes are capable of being separated intensively, moved to one end of the container, and then collected so as to be removed from the semiconductor carbon nanotubes.

This invention also has other embodiments which are not described herein; for example: the electromagnetic pole 201 and the magnetic pole 202 are alternated repeatedly, and the polarities of the magnetic poles 201 and 202 or the polarities of the electrodes 203 and 204 exchange according to the alternation discipline of the magnetic poles 201 and 202; Or, the magnetic pole of the permanent magnet is replaced by an electromagnet, so the polarity exchange of the magnetic poles is capable of being realized just by changing the current direction.

By means of the design discipline of this invention, the integrated circuit material, including the semiconductor carbon nanotubes, the metallic carbon nanotubes and the monoatomic-layered carbon, etc., are capable of being separated.

### INDUSTRIAL APPLICATION

In this invention, the metallic carbon nanotubes and the semiconductor carbon nanotubes are separated by a simple and reliable method. According to this method, the separation technology is of high selectivity and the purity of the separated materials is superior to that obtained by the prior art, because the metallic carbon nanotubes and the semiconductor carbon nanotubes are characterized in different conductivities in particular magnetic fields.

1. A method for separating the carbon nanotube materials with different conductive properties is specifically comprised of the following steps:
a) soaking an integrated circuit material in fluid, wherein the integrated circuit material at least comprises a mixture of metallic carbon nanotubes and semiconductor carbon nanotubes; the fluid is non-conductive or high-resistance;
b) pouring the fluid into a container;
c) setting an electric field and a pair of magnetic poles which form magnetic lines and are vertical to the electric field around the container, wherein both the magnetic lines of the pair of magnetic poles and the electric lines of the electric field penetrate the container;
d) changing the directions and lengths of the electric lines of the electric field and those of the magnetic lines, wherein the integrated circuit material under the act of the varying electric field and magnetic field forces the metallic carbon nanotubes and the semiconductor carbon nanotubes to be separated;
e) respectively collecting the separated integrated circuit materials.

2. The method for separating the carbon nanotube materials with different conductive properties of claim 1 the magnetic field generated by the pair of magnetic poles is a permanent magnetic field or an electromagnetic field with an intensity of 0.00001-10 T.
